(19) United States
(12) Patent Application Publication
(10) Pub. No.: US 2014/0269608 A1
(43) Pub. Date: Sep. 18, 2014

(54) OFDM TRANSMISSION METHOD AND APPARATUS

(71) Applicant: ELECTRONICS AND TELECOMMUNICATIONS RESEARCH INSTITUTE, Daejeon-si (KR)

(72) Inventors: Joon Young JUNG, Daejeon (KR); Dong Joon CHOI, Daejeon (KR); Nam Ho HUR, Daejeon (KR)

(73) Assignee: ELECTRONICS AND TELECOMMUNICATIONS RESEARCH INSTITUTE, Daejeon-si (KR)

(21) Appl. No.: 14/096,732

(22) Filed: Dec. 4, 2013

(30) Foreign Application Priority Data
Mar. 14, 2013 (KR) 10-2013-0027185

(51) Int. Cl. H04L 5/00

(52) U.S. Cl. CPC H04L 5/0007
USPC 370/330; 370/329

(57) ABSTRACT

Disclosed are an OFDM transmission method and apparatus. In the present invention, channel bonding information includes at least one of information indicating whether or not a channel through which the transport frame is transmitted is a bonded channel, information indicating how many channels form the bonded channel, and information about a transmission frequency of each of the bonded channels.

Priority to Korean patent application number 10-2013-0027185 filed on Mar. 14, 2013, the entire disclosure of which is incorporated by reference herein, is claimed.

### BACKGROUND OF THE INVENTION

1. Field of the Invention

The present invention relates to an Orthogonal Frequency Division Multiplexing (OFDM) method and, more particularly, to a method of bonding channels at the time of OFDM transmission.

2. Discussion of the Related Art

Recently, a transmission method for digital communication and broadcasting is being developed from a single carrier modulation method to a multi-carrier modulation method. The single carrier method is a method of carrying information on one carrier frequency within a given frequency band and transmitting the information, and the multi-carrier method is a method of carrying information on one or more subcarriers within a given band and transmitting the information. Assuming that the time taken to transmit one transmission symbol is called T in the single carrier method and N subcarriers having the same transfer rate within the same frequency band are used in the multi-carrier method, the time that is taken for each subcarrier to send one transmission symbol is ‘N*T’. That is, the multi-carrier method is advantageous in terms of high-speed data transmission because the length of the transmission symbol of each subcarrier is very longer than that of the symbol of a single carrier and thus interference between symbols is reduced.

An Orthogonal Frequency Division Multiplexing (OFDM) transmission method is a kind of multi-carrier method and has recently been adopted and used in a WLAN, mobile communication, and digital broadcasting. In particular, in Digital Video Broadcasting (DVB), that is, the European digital broadcasting standardization organization, DVB-T2 and DVB-C2 standards have been developed as the next-generation broadcasting transmission standard and OFDM is adopted as a transmission method.

Meanwhile, in digital broadcasting, service picture quality is changed from Standard Definition (SD) broadcasting to High Definition (HD), and the introduction of Ultra High Definition (UHD) broadcasting providing picture quality 4 to 16 times higher than HD broadcasting is being discussed.

The amount of data transmitted for UHDTV service is very greater than that of existing HDTV. Even in the digital broadcasting standard of DVB adopting the OFDM transmission method, a frequency band occupied per channel is limited to 6 or 8 MHz and thus the amount of data that can be transmitted through one channel is limited to a channel capacity. Accordingly, if a data transfer rate having a large amount of data, such as UHDTV to appear in the future, it is very difficult to provide service through one channel.

Furthermore, even in wireless and mobile communication, the amount of transmitted data is recently increased explosively because the number of users is increased and a variety of mobile services appear, and users increasingly need faster service. A maximum data transfer rate is limited because a limited transport channel is used even in communication, such as digital broadcasting.

As described above, there is a need for a higher data transfer rate in broadcasting and communication service environments having a limited transport channel.

### SUMMARY OF THE INVENTION

An object of the present invention is to provide a method and apparatus for bonding and transmitting a plurality of channels in an OFDM transmission method.

In accordance with an aspect of the present invention, an OFDM transmission method includes generating a transport frame including a preamble period including channel bonding information, controlling the transport frame so that the transport frame is temporally synchronized with the transport frames of other channels, and transmitting the synchronized transport frames through at least one of channel-bonded channels.

In accordance with another aspect of the present invention, an OFDM reception method includes receiving a transport frame, including a preamble period including channel bonding information, through a plurality of channels, rearranging data, distributed over and transmitted through the plurality of channels, based on the transport frame, bonding the rearranged data into one data stream based on the channel bonding information, and obtaining the data from the data stream.

### BRIEF DESCRIPTION OF THE DRAWINGS

FIG. 1 shows an example of a transport frame within a transport channel to which the present invention is applied;

FIG. 2 shows an example of a method of bonding and transmitting a plurality of channels in accordance with the present invention;

FIG. 3 shows an example of a method of bonding and transmitting a plurality of channels in accordance with the present invention;

FIG. 4 is a diagram showing an example of the data structure of a preamble transmitted in the transport frame in accordance with the present invention;

FIG. 5 is a flowchart illustrating an example of a method of performing OFDM;

FIG. 6 is a flowchart illustrating an example of a method of performing OFDM reception; and

FIG. 7 is a block diagram showing an example of an apparatus for performing OFDM.

### DETAILED DESCRIPTION OF THE EMBODIMENTS

Hereinafter, embodiments of the present invention will be described in detail with reference to the accompanying drawings so that they can be readily implemented by those skilled in the art.

Hereinafter, some embodiments of the present invention are described in detail with reference to the accompanying drawings in order for a person having ordinary skill in the art to which the present invention pertains to be able to readily implement the invention. It is to be noted the present invention may be implemented in various ways and is not limited to the following embodiments. Furthermore, in the drawings, parts not related to the present invention are omitted in order to clarify the present invention and the same or similar reference numerals are used to denote the same or similar elements.

The objects and effects of the present invention can be naturally understood or become clear by the following description, and the objects and effects of the present invention are not restricted by the following description only.

The objects, characteristics, and merits will become more apparent from the following detailed description. Furthermore, in describing the present invention, a detailed description of a known art related to the present invention will be omitted if it is deemed to make the gist of the present invention unnecessarily vague. A preferred embodiment in accordance with the present invention is described in detail below with reference to the accompanying drawings.

Hereafter, the transmission structure of the DVB-C2 standard for digital cable broadcasting is described as an example of the present invention, but the present invention is not limited thereto. The present invention can be applied to several communication and broadcasting methods using an OFDM transmission method.

FIG. 1 shows an example of a transport frame within a transport channel to which the present invention is applied. For example, the transport frame can be a transport frame within the transport channel of the DVB-C2 standard that uses Orthogonal Frequency Division Multiplexing (OFDM).

Referring to FIG. 1, the OFDM transport frame can be configured to include several tens or several hundreds of data symbols starting from one or more preamble symbols.

For example, the transport frame of the DVB-C2 standard can include preambles each including 1 to 8 OFDM symbols and data symbols including 448 OFDM symbol.

The configured transport frame is repeatedly and consecutively transmitted through a transport channel.

Here, in a receiver, time and frequency synchronization can be provided through a preamble.

Or, in the receiver of the DVB-C2 standard, not only time and frequency synchronization, but also the transmission structure of a physical layer may be provided through the preamble. Here, the transmission structure of the physical layer can be basically divided into a ‘data slice’ and a ‘Physical Layer Pipe (PLP)’ in the case of DVB-C2. Several data slices can be configured within one transmission band (or signal), and one data slice can include several PLPs. The contents of this configuration are called the transmission structure of the physical layer.

In the OFDM transmission method, an agreed training sequence or a pilot signal can be transmitted to a receiver through a preamble symbol.

Or, in the DVB-C2 standard, the pilot signal can be inserted at six-subcarrier interval through the preamble symbol, and the transmission structure of the physical layer where a data cell is placed can be transferred to the receiver in the remaining subcarriers. For example, data indicative of the transmission structure of the physical layer can be transmitted in a preamble period.

Meanwhile, in the OFDM transmission method, the frequency band of a transport channel has a limited range. For example, the frequency band of the transport channel can be 6 or 8 MHz. The amount of data that can be transmitted within one transport channel is limited due to a frequency band having a limited range as described above.

FIG. 2 shows an example of a method of bonding and transmitting a plurality of channels in accordance with the present invention. For example, the channel can be 6 MHz.

Referring to FIG. 2, the following two conditions can be satisfied in order to couple and transmit the plurality of channels.

First, the transport frame of each channel is temporally synchronized with the transport frames of other channels (210). That is, transmission can be performed in such a manner that a point of time at which the transport frame is started is precisely matched every channel. This is for rearranging data distributed over and transmitted through channels in a receiver. If transport frames are not synchronized with each other between the channels, it is difficult for the receiver to determine that the data of the transport frames will be taken according to what order when rearranging transport data symbols. Accordingly, the transport frame of a channel that is used to couple channels is temporally synchronized with other transport frames.

Second, the preamble period of each channel includes information about channel bonding (220). Based on the information about channel bonding, a receiver can determine whether or not a corresponding channel is a coupled channel, determine how many channels are coupled, determine the transmission frequency of each coupled channel, and data, transmitted through the channels, into one data stream.

Meanwhile, in the DVB-C2 standard, the transport frame can be a DVB-C2 frame.

Furthermore, a guard band 230 can be placed between the transport channels. Furthermore, a frequency bandwidth can be 6 MHz and can be 5.71 MHz if the guard band is excluded.

Furthermore, the preamble can include 1 to 8 OFDM symbols, and each data symbol can include 448 OFDM symbols.

FIG. 3 shows an example of a method of bonding and transmitting a plurality of channels in accordance with the present invention. In FIG. 3, the time axis and the frequency axis of FIG. 2 are exchanged and shown.

Referring to FIG. 3, as described with reference to FIG. 2, transport frames transmitted through respective channels are temporally synchronized with each other (310).

Furthermore, the preamble symbol of each transport frame includes information for channel bonding (320).

FIG. 4 is a diagram showing an example of the data structure of a preamble transmitted in the transport frame in accordance with the present invention.

For example, the preamble of the transport frame can be a preamble used in the DVB-C2 standard.

Furthermore, the data structure of the preamble, that is, the data structure inputted to a preamble period, can be an L1 signaling data structure. Here, a physical layer structure is described through L1 signaling data.

Referring to FIG. 4, a preamble period within the transport frame includes a pilot cell 410 for frequency and timing synchronization and data cells 420 to 450 describing the physical layer structure.

The structure of L1 signaling data inputted to the preamble period includes a preamble header 410 and L1 signaling data 420.

The preamble header 410 indicates the length of the L1 signaling data. That is, the preamble header 410 can include information about the length of the L1 signaling data.

For example, the length of the L1 signaling data can be indicated by ‘½ of the number of bits of the L1 signaling data’. If the number of bits of the L1 signaling data is an odd number, 1-bit L1 block padding 430 can be performed.

Furthermore, a CRC code 440 for the L1 signaling data 420 can be included.

Furthermore, if the L1 signaling data does not reach a specific length (also called a ‘specific length value’), zero padding 450 can be performed until the length of the L1 signaling data becomes the specific length. This is because signaling data must be a block having a specific length for channel error correction coding.

In an embodiment of the present invention, in order to include information about channel bonding in the preamble period and send the information, channel bonding information 460 can be added to the part of the zero padding 450 after the L1 signaling data. That is, the channel bonding information 460 can be added instead of the zero padding because the total sum of the L1 signaling data does not reach the length for channel error correction coding.

Table 1 shows an example of the structure and syntax of the channel bonding information (or channel bonding data) transmitted in accordance with the present invention.

TABLE 1

| SYNTAX | BITS | |
|---|---|---|
| channel_bonding_info( ) { | | |
| info_tag | 8 | 0xEE |
| num_channels | 8 | |
| for i = 0 ~ num_channels −1 { | | |
| channel_id | 8 | |
| channel_start_frequency | 32 | |
| channel_band_width | 32 | |
| } | | |
| CRC8 | 8 | |

Referring to Table 1, the data fields included in the structure of the channel bonding information structure are defined as follows.

‘channel_bonding_info( )’ refers to channel bonding information.

‘info_tag’ is a field indicative of a channel bonding data structure, and it can have a value, for example, ‘0xEE’. The ‘0xEE’ value can be changed into a specific value.

‘num_channels’ is a field indicative of the number of channels included in channel bonding, and it can be, for example, an 8-bit integer value without a sign.

‘channel_id’ is an ID field for identifying each channel included in channel bonding, and it can be, for example, an 8-bit integer value without a sign.

‘channel_start_frequency’ is a field indicative of the start frequency value Hz of each channel included in channel bonding, and it can be, for example, a 32-bit integer value without a sign.

‘channel_band_width’ is a field indicative of the bandwidth Hz of each channel included in channel bonding, and it can be, for example, a 32-bit integer value without a sign.

‘CRC8’ is a field indicative of a checksum value, that is, a result of error check (e.g., ‘CRC8’) for data defined in the channel bonding information structure, and it can be, for example, an 8-bit value.

FIG. 5 is a flowchart illustrating an example of a method of performing OFDM transmission.

Referring to FIG. 5, a transmission terminal configures a transport frame so that a preamble includes channel bonding information at step S500. The channel bonding information can include at least one of the parameters listed in Table 1.

The transmission terminal arranges the transport frames of channels so that the transport frame of each channel is temporally synchronized with the transport frames of other channels at step S505.

The transmission terminal transmits the transport frames through all the channels included in channel bonding at step S510.

FIG. 6 is a flowchart illustrating an example of a method of performing OFDM reception.

Referring to FIG. 6, a reception terminal receives a transport frame including channel bonding information at step S600. Here, the channel bonding information can include information indicating whether or not a channel is a bonded channel, information indicating that how many channels have been bonded, or information about the transmission frequency of each bonded channel.

Next, the reception terminal rearranges data distributed over and transmitted through the channels at step S605.

Next, the reception terminal bonds the data, received through the channels, into one data stream based on channel bonding information included in a preamble period at step S610. For example, the reception terminal can determine whether or not a channel is a bonded channel, determine how many channels have been bonded, or determine the transmission frequency of each channel based on the channel bonding information.

Next, the reception terminal obtains the data from the data stream at step S615.

FIG. 7 is a block diagram showing an example of an apparatus for performing OFDM transmission.

Referring to FIG. 7, the transmission terminal 700 includes a frame generation unit 710, a synchronization unit 720, and a transmission unit 730.

The frame generation unit 710 generates a transport frame so that a preamble included in each frame includes channel bonding information. Here, the channel bonding information can include at least one of the parameters listed in Table 1.

The synchronization unit 720 arranges the transport frames of channels so that the transport frame of each channel is temporally synchronized with the transport frames of other channels.

The transmission unit 730 transmits the generated and synchronized transport frames through all the channels included in channel bonding.

Meanwhile, the reception terminal 750 includes at least one reception module 760, a data rearrangement unit 770, a data bonding unit 780, and a data acquisition unit 790.

It is assumed that the reception terminal 750 has an ability to interpret channel bonding information in order to support channel bonding.

The reception module 760 receives a transport frame including channel bonding information. Here, the channel bonding information can include information indicating whether or not a channel is a bonded channel, information indicating that how many channels have been bonded, or information about the transmission frequency of each bonded channel.

The reception terminal 750 can include a plurality of the reception modules 760 in order to receive a plurality of bonded channels. The reception module 760 can include a tuner or a demodulator.

The data rearrangement unit 770 rearranges data distributed over and transmitted through the channels.

The data bonding unit 780 bonds the data, received through the channels, into one data stream based on the channel bonding information included in a preamble period. For example, the data bonding unit 780 can determine whether or not a channel is a bonded channel, determine how many channels have been bonded, or determine the transmission frequency of each channel based on the channel bonding information.

The data acquisition unit 790 obtains the data from the data stream.

In accordance with the present invention, a data transfer rate can be increased.

In accordance with the present invention, a transmission capability can be extended.

In accordance with the present invention, in communication and broadcasting services, a large amount of multimedia data having a great bandwidth can be transmitted, and realistic broadcasting service having high quality can be provided in a short time.

A person having ordinary skill in the art to which the present invention pertains may change and modify the present invention in various ways without departing from the technical spirit of the present invention. Accordingly, the present invention is not limited to the above-described embodiments and the accompanying drawings.

In the above exemplary system, although the methods have been described based on the flowcharts in the form of a series of steps or blocks, the present invention is not limited to the sequence of the steps, and some of the steps may be performed in a different order from that of other steps or may be performed simultaneous to other steps. Furthermore, those skilled in the art will understand that the steps shown in the flowchart are not exclusive and the steps may include additional steps or that one or more steps in the flowchart may be deleted without affecting the scope of the present invention.

What is claimed is:

1. An Orthogonal Frequency Division Multiplexing (OFDM) transmission method, comprising:
generating a transport frame comprising a preamble period comprising channel bonding information;
controlling the transport frame so that the transport frame is temporally synchronized with transport frames of other channels; and
transmitting the synchronized transport frames through at least one of channel-bonded channels.

2. The OFDM transmission method of claim 1, wherein:
the preamble period further comprises time and frequency synchronization information, and
the transport frame is temporally synchronized with other frames based on the time and frequency synchronization information.

3. The OFDM transmission method of claim 1, wherein the channel bonding information comprises at least one of information indicating whether or not a channel through which the transport frame is transmitted is a bonded channel, information indicating how many channels form the bonded channel, and information about a transmission frequency of each of the bonded channels.

4. The OFDM transmission method of claim 1, wherein:
the channel bonding information comprises a field indicative of a channel bonding data structure,
the channel bonding information comprises a field indicative of a number of the channels included in the channel bonding,
the channel bonding information comprises an ID field for identifying each of the channels included in the channel bonding,
the channel bonding information comprises a field indicative of a start frequency value Hz of each of the channels included in the channel bonding,
the channel bonding information comprises a field indicative of a bandwidth Hz of each of the channels included in the channel bonding, or
the channel bonding information comprises a field indicative of a checksum value obtained by performing error check on data defined within the channel bonding information structure.

5. An Orthogonal Frequency Division Multiplexing (OFDM) reception method, comprising:
receiving a transport frame, comprising a preamble period comprising channel bonding information, through a plurality of channels;
rearranging data, distributed over and transmitted through the plurality of channels, based on the transport frame;
bonding the rearranged data into one data stream based on the channel bonding information; and
obtaining the data from the data stream.

6. The OFDM reception method of claim 5, wherein the channel bonding information comprises at least one of information indicating whether or not a channel through which the transport frame is transmitted is a bonded channel, information indicating how many channels form the bonded channel, and information about a transmission frequency of each of the bonded channels.

7. The OFDM reception method of claim 6, wherein:
the channel bonding information comprises a field indicative of a channel bonding data structure,
the channel bonding information comprises a field indicative of a number of the channels included in the channel bonding,
the channel bonding information comprises an ID field for identifying each of the channels included in the channel bonding,
the channel bonding information comprises a field indicative of a start frequency value Hz of each of the channels included in the channel bonding,
the channel bonding information comprises a field indicative of a bandwidth Hz of each of the channels included in the channel bonding, or
the channel bonding information comprises a field indicative of a checksum value obtained by performing error check on data defined within the channel bonding information structure.

8. A transmission apparatus, comprising:
a frame generation unit for generating a transport frame so that channel bonding information is included in a preamble period included in each frame;
a synchronization unit for arranging the transport frames so that the transport frame is temporally synchronized with transport frames of other channels; and
a transmission unit for transmitting the transport frame through all the channels included in channel bonding.

9. The transmission apparatus of claim 8, wherein:
the preamble period further comprises time and frequency synchronization information, and
the transport frame is temporally synchronized with other frames based on the time and frequency synchronization information.

10. The transmission apparatus of claim 8, wherein the channel bonding information comprises at least one of information indicating whether or not a channel through which the transport frame is transmitted is a bonded channel, information indicating how many channels form the bonded channel, and information about a transmission frequency of each of the bonded channels.

11. The transmission apparatus of claim 8, wherein:
the channel bonding information comprises a field indicative of a channel bonding data structure,
the channel bonding information comprises a field indicative of a number of the channels included in the channel bonding,
the channel bonding information comprises an ID field for identifying each of the channels included in the channel bonding,
the channel bonding information comprises a field indicative of a start frequency value Hz of each of the channels included in the channel bonding,
the channel bonding information comprises a field indicative of a bandwidth Hz of each of the channels included in the channel bonding, or
the channel bonding information comprises a field indicative of a checksum value obtained by performing error check on data defined within the channel bonding information structure.
